(19) United States
(12) Patent Application Publication
(10) Pub. No.: US 2017/0037832 A1
(43) Pub. Date: Feb. 9, 2017

(54) Wind Turbine with Floating Foundation and Position Regulating Control System and Method Thereof

(71) Applicant: Envision Energy (Denmark) ApS, Silkeborg (DK)

(72) Inventors: Michael Friedrich, Silkeborg (DK); Rune Rubak, Silkeborg (DK)

(21) Appl. No.: 15/304,073

(22) PCT Filed: Mar. 24, 2015
(86) PCT No.: PCT/DK2015/050065

§ 371 Date: Oct. 14, 2016

(30) Foreign Application Priority Data
Apr. 14, 2014 (DK) PA 2014 70213

(51) Int. Cl. F03D 13/25; G05D 1/08; F03D 7/04; B63B 35/44; F03D 7/02; F03D 9/32

(52) U.S. Cl. CPC F03D 13/25; F03D 7/0228; F03D 9/32; F03D 7/042; B63B 35/44; G05D 1/0875; B63B 2035/446

(57) ABSTRACT

The present invention relates to a wind turbine structure comprising a wind turbine tower with a nacelle arranged on the top to which a rotor hub with one or more rotatable mounted wind turbine blades are mounted which form a rotor plane. A floating foundation is mounted to the bottom of the wind turbine tower and the pitch and/or yaw system are used to regulate the position of the wind turbine structure. A control unit detects the relative movement of the wind turbine structure in two axial directions and activates the pitch or yaw system to move the wind turbine structure into an equilibrium position. This reduces the directional movement of the wind turbine structure so that it remains in a stable equilibrium position. This also reduces the oscillating movement and tension forces in the anchor chains.

The application claims the benefit of Danish Application No. PA 2014 70213 filed Apr. 14, 2014 and PCT/DK2015/050065 filed Mar. 24, 2015, which are hereby incorporated by reference in their entirety as if fully set forth herein.

### FIELD OF THE INVENTION

The present invention relates to a wind turbine structure comprising:
a wind turbine tower having a top and a bottom,
a nacelle arranged on top of the wind turbine tower,
a rotor hub rotatably mounted to the nacelle,
one or more pitchable wind turbine blades with a tip end and a blade root mounted to the rotor hub,
a floatable foundation having an upper section mounted to the bottom of the wind turbine tower, wherein the foundation comprises a buoyant body configured to be installed at an offshore position,
a mooring system having a plurality of catenary mooring lines, the mooring system is connected to the foundation and to at least one anchor arranged on a seabed, wherein the wind turbine structure comprises at least one control unit connected to at least a pitch system configured to pitch the wind turbine blades and at least one measuring unit connected to the control unit, the measuring unit is configured to measure an axial movement of the wind turbine structure along at least one axis in a horizontal plane.

The present invention also relates to a method of controlling a wind turbine structure as described above, wherein the method comprises the steps of:
pitching the wind turbine blades into a pitch angle at mean wind speeds above a first wind speed, wherein the pitching is controlled by means of a control unit,
measuring an axial movement of the wind turbine structure in the horizontal plane,
determining the relative movement of the wind turbine structure relative to a predetermined position, and
moving the wind turbine structure relative to a predetermined position in at least a horizontal plane.

### BACKGROUND OF THE INVENTION

It is known to use a mooring system to secure the floating foundation to a desired location using a number of long and heavy chains each connected to an anchor placed on the seabed and to a mooring line extending from the foundation. Such a catenary mooring system uses gravity and friction between the seabed, anchors and part of the anchor chains to keep the foundation within a limited area. The floating foundation is able to move in a horizontal and vertical direction relative to the seabed and away from its initial position due to the various wind and marine (wave and current) forces acting on the moored structure. This relative movement causes some anchor chains to tighten and other anchor chains to slack and thereby varying the tension force in the individual anchor chains. The tension generated in the anchor chains due to the movement are an important factor when determining the size and weight of such a mooring system.

It is known that the low-frequency spectrum of these marine forces is likely to resonate with the natural frequencies of the catenary mooring system and foundation which further leads to an enhanced movement or oscillation in the anchor chains, particularly moving a chain section in and out of contact with the seabed (called thrashing). This continuous oscillation subjects the chain links and various other chain components to a constant wear due to the dynamic loads. This reduces the lifetime of the mooring system. The lifetime may be further reduced due to the corrosive environment of the seawater. The marine forces acting on the moored structure also influences the resulting thrust acting on the rotor hub. This becomes an issue at wind speeds over 18 to 22^{m}/ₛ, e.g. 20^{m}/ₛ.

The wind force acting on the rotor plane depends on the density of the incoming wind and is an important factor when determining the size and weight of such a floating foundation. A major problem thereof is that the pitching of the wind turbine blades causes an oscillating tilt or angular rotation (relative to a horizontal direction) of the wind turbine unit due to the resulting thrust acting on the rotor hub. This becomes an issue at wind speeds over 10 to 14^{m}/ₛ, e.g. 12^{m}/ₛ (also called rated wind speed).

US 2011/0037264 A1 discloses a wind turbine placed on a three-legged platform secured to the seabed by using a plurality of mooring lines each connected to an anchor which is placed on the seabed. It teaches that the floating foundation is able to move relative to its initial position due to the various forces acting on the foundation, and thereby changing the tension in the individual mooring lines. A large heavy mass is suspended from each of the mooring lines for reducing the angle of the mooring lines relative to the vertical direction of the platform and provides a more taut mooring line. Such a clump weight system adds to the total costs of the structure, generates shock loads in the anchor chain as it hits the seabed, and is likely to get stuck in the seabed if the seabed has a soft composition. It further teaches that the movement of floating foundation generates significant loads and stress on the electrical cables extending into the seabed. This is solved by adding a passive buoyancy element to the electrical cables for forming a cable loop which enables the structure to move without damaging the electrical cables.

US 2011/0037264 A1 also teaches that a pre-tensioning force is applied to each mooring line by using a tensioning system after which the tensioning system is locked in that setting. Such semi-taut mooring lines mean that the size and weight of each anchor or anchor block need to be increased, thereby increasing the total costs of structure and require a more complex and costly solution.

US 2014/0044541 A1 discloses a park comprising a plurality of wind turbines each placed on a floating foundation connected to a buoy via a rotatable support arm which further comprises a hinge allowing the foundation and support arm to pivot relative to the buoy. A thruster located on the bottom of the foundation is used to actively rotate the foundation relative to the buoy. In another embodiment, the foundation is secured to the seabed via three mooring lines that are connected individually to a drive pulley. The drive pulleys are actively controlled by a controller configured to adjust the position of the wind turbine based on the sensed wind direction and wind speed. The document is silent about whether a position sensor is used or not.

The solutions in US 2011/0037264 A1 and US 2014/0044541 A1 are designed to reduce the wake effect experienced in a wind turbine park by moving the wind turbine out of the turbulent wind so that the power production can be improved. The use of a support arm and buoy add to the complexity of the total system and only allows for a lateral movement of the wind turbine relative to the buoy. In this configuration, the wind turbine will move together with the buoy due to a stiff support arm which will introduce additional loads in the wind turbine structure as the control unit moves it laterally out of the wake effect. The drive pulleys require the mooring lines to be taut which in turn require larger and heavier anchors in order to compensate for increased tension forces in the mooring lines when the wind turbine is moved. This adds to the costs of the total system.

Similar mooring systems are used in the offshore gas and oil industry to secure the offshore platforms and rigs; however, the wind loads on these structures are significantly lower than the wind loads on offshore wind turbines.

EP 2457818 A1 discloses a method of reducing an oscillating movement of a floating wind turbine structure by controlling the operation of thrusts provided on the floating foundation based on the measured displacement or the real-time speed of the wind turbine using a position sensor. This document is silent about how the thrusters are operated to dampen these oscillating movements. Furthermore, EP 2457818 A1 teaches that the pitch control of the wind turbine blades is independent of the thrust control so that the power output is not negatively affected.

US 2010/0003134 A1 discloses a method for preventing resonance between the floating foundation and the forces acting on the foundation. EP 2489872 A1 discloses a method of reducing the gyroscopic loads in the wind turbine blade caused by the tiling movement of the floating wind turbine. EP 2685093 A1 and WO 2013/065323 A1 disclose methods of dampening the tilting movement of the floating wind turbine.

### OBJECT OF THE INVENTION

An object of this invention is to provide a floating wind turbine configuration that dampens the oscillating forces generated in the mooring system.

An object of this invention is to provide a wind turbine that allows the dynamic forces acting on the wind turbine structure to be damped in an active manner

An object of this invention is to provide a method of actively adjusting the position of a wind turbine to dampen the oscillating movement of the wind turbine structure.

### DESCRIPTION OF THE INVENTION

The term “axial movement” is defined as movement, e.g. offsetting, of the wind turbine relative to an initial position in any direction along at least one of the x-, y-, z-axes. Movement along the x-axis is defined as movement perpendicular to the rotation plane formed by the wind turbine blades (parallel to the prevailing wind direction). Movement along the z-axis is defined as movement parallel to the rotation plane (perpendicular to the prevailing direction of the incoming wind). Movement along the y-axis is defined as movement parallel to the longitudinal direction of the wind turbine tower. The x- and z-axes define a horizontal plane used to determine the position, e.g. global position, of the wind turbine structure while the x- and y-axes define a vertical plane for the wind turbine structure.

The term “wind turbine” is defined as the rotor (rotor hub and wind turbine blades), the nacelle, and the wind turbine tower. The term “wind turbine structure” defines the wind turbine and the floating foundation. The term “equilibrium position” is defined as a position in which the various forces and thrusts acting on the wind turbine structure are in equilibrium and the wind turbine structure is static or quasi-static stable. The rotor hub or mounting joint between the foundation and the wind turbine tower is used as a reference point when determining the relative movement and various forces. Alternatively, the connection point between a selected mooring line and the foundation may be used as the reference point.

An object of the invention is achieved by a wind turbine structure characterised in that:
the control unit is configured to detect the relative movement of the wind turbine structure relative to a predetermined position in at least two directions along the one axis within a predetermined time window, and
if movement in two opposite directions is detected, the control unit is then configured to move the wind turbine structure in the horizontal plane by regulating the thrust acting on the rotor based on the relative movement to reduce the constant wear in the mooring system.

This provides an offshore wind turbine structure capable of dampening the dynamic or cyclic movements of the wind turbine structure in at least the horizontal plane. The horizontal plane may be defined by the mean water level at the installation site. This enables the constantly shifting movement of the wind turbine structure in opposite directions caused by the dynamic or cyclic forces to be damped. The wind turbine itself is used to apply an additional restoring force to the wind turbine structure which stabilises the wind turbine structure. This keeps the wind turbine structure stabilized during various wind, wave and current conditions and reduces the dynamic loads.

If a traditional passive mooring system is used, the restoring force is introduced into the wind turbine structure by increasing the volume of the floating foundation, by adding ballast to the floating foundation, or by increasing the tension force in the mooring lines. Unlike US 2014/0044541 A1, the present invention uses the thrust acting on the rotor to actively dampen the relative movement of the wind turbine structure. By dampening the shifting directional movement of the wind turbine structure this in turn dampens the oscillating movement in the anchor chains as the frequency of moving is shifted away from the resonant frequency of the mooring system. This reduces the constant wear in the mooring system and increases the lifetime thereof and further allows the size and weight of the mooring system to be reduced and thereby saving costs.

This configuration is suitable for any type of floatable foundation or platform having at least one buoyancy chamber. The foundation may have a concrete or metal structure, e.g. of steel. The foundation may comprise at least three buoyancy chamber interconnected to form the desired structure. The foundation may be shaped as a spar buoy or a cylindrical, triangular, squared or polygonal structure. One or more stabilising elements, e.g. a plate, an arm or a weight, may be arranged relative to the foundation for increasing the stability of the foundation. The stabilising elements may be designed to counteract the tilting or rotating movement of the wind turbine around one of the axes. The buoyancy chamber may be a ballast chamber, e.g. connected to ballast regulating means, such as a pumping system.

The mooring system comprises at least three mooring lines, e.g. catenary mooring lines, extending outwards from the foundation and connected to corresponding anchors. The mooring lines may further be arranged in individual groups connected to the foundation at individual connection points. Each anchor is connected to at least one anchor chain which at the other end is connected directly to foundation or via a second type of mooring line. A large and heavy anchor chain of metal, e.g. steel, or another suitable material is connected to at least the anchor. A thinner and lighter anchor chain and/or a wire or rope of Nylon, plastic, polyester, synthetic fibres or any other suitable material may be connected to the foundation and the larger and heavier anchor chain. This forms a mooring line with at least two segments each having a predetermined mass and weight thereby allowing the weight distribution and the restoring force or stiffness of the mooring system to be optimized relative to the frequency spectrum of the forces acting on the wind turbine structure.

The measuring unit(s) measures the current position of the mooring system and thus the wind turbine structure relative to a reference position. This enables the control unit to detect any axial movements of the wind turbine in at least the horizontal plane, such as in two opposite directions along the same axis, e.g. the x- or z-axis, and/or in two perpendicular directions along two of the axes, e.g. the x- and z-axes. This allows the control unit to detect any oscillating or cyclic movements which would cause the wind turbine structure to relative quickly change its position. If the control unit detects a relative movement in at least two directions within a predetermined time window, then the control unit activates the pitch and/or yaw system to counteract this movement. If the control unit detects that the wind turbine structure is only moved in substantially one direction, then the pitch and/or yaw system is not activated. This allows the wind turbine structure to move between equilibrium positions in any direction due to the various static forces acting on the wind turbine structure while dampening the oscillating movements.

The control unit may instead determine the relative movement of the wind turbine structure based on at least the tension force measured in one or more mooring lines, or vice versa. The axial movement of the wind turbine structure may be proportional to the tension force in the respectively mooring line(s). The measuring units may be able to measure the tension force in at least two directions, e.g. along the x- and z-axes, thereby enabling the control unit to detect any oscillating or cyclic loads in the anchor chains which cause a constant wear in the anchor chains. The direction of these tension forces is used to determine in which direction the wind turbine structure should be moved.

According to one embodiment, the time window is less than 3 minutes, preferably between 10 to 120 seconds

The control unit may monitor the relative movement within a time window determined as function of the wind speed hitting the rotor plane and/or the speed in which the wind turbine structure moves. The time window may be less than 3 minutes, preferably between 10 and 120 seconds.

In a special embodiment, the control unit is configured to compare the tension force, or the relative movement, in at least one of the two directions to at least one threshold, wherein the control unit is configured to adjust the thrust acting on the rotor if the tension force, or the relative movement, exceeds that threshold.

This enables the wind turbine to adjust its geographic position if the relative movement in one or both directions exceeds a predetermined threshold value.

According to one embodiment, the at least one threshold is between 50 to 200 centimetres, e.g. 100 centimetres.

The threshold value may be the same for both directions or differ for each direction. The threshold value may be determined as function of the wind speed hitting the rotor plane and/or the speed at which the wind turbine structure moves. The threshold value may instead be selected between 50 to 200 centimetres, e.g. 100 centimetres. This allows the wind turbine structure to move within a predetermined geographic area where the wind turbine is operated according to a maximum power production scheme. If the wind turbine moves/drifts out of this area, then the pitch and/or yaw system are active to move the wind turbine structure inside this area again. The threshold value and time window may further be used to define a maximum allowable speed for the relative movement of the wind turbine structure. This enables the wind turbine structure to slowly move around due to the forces acting on the structure while dampening any fast movements.

The control unit may additionally or alternatively compare the measured or calculated tension force in one or both directions to one or more threshold values. The threshold values define a maximum allowable displacement of the wind turbine structure relative to its initial position. If at least one of the tension forces exceeds the threshold value, then the pitch and/or yaw system are activated to dampen the tension in the mooring lines. This reduces the maximum tension force in the anchor chains when the wind turbine structure is located in an outer position. Furthermore, this increases the lifetime of the mooring system and allows the wind turbine structure to move within a predetermined area.

In one embodiment, the control unit is configured to determine a correction pitch angle based on the tension force, or the relative movement.

This configuration enables the pitch system of the wind turbine to be used to move/push the wind turbine structure along the x- and/or z-axis. In this configuration, the control unit may act as a wind turbine control unit configured to control the operation of the wind turbine. Alternatively, the control unit may be connected to a separate wind turbine control unit via a wired or wireless connection. The control unit is configured to adjust the pitch angle of the wind turbine blades based on the relative movement which in turn regulates the thrust acting on the rotor hub. This corrected pitch angle is indicative of the direction in which the wind turbine structure needs to be moved to dampen the oscillating movements. The corrected pitch angle is then transmitted to the pitch system which in turn adjusts the pitch angle accordingly. If no correction is needed, then an optimal pitch angle for maximum power production may be transmitted to the pitch system. The correct pitch angle for reducing the relative movement of the wind turbine structure and thus the oscillating movements in the anchor chains may be the same or differ from the optimal pitch angle for maximum power output. This reduces the number of additional components needed to move the wind turbine structure since the wind turbine itself is used to move the wind turbine structure, thus allowing for an easy implementation in an existing floating wind turbine.

A look-up table or a continuous calculation based on at least the measurement of the wind direction and/or mean wind speed may be used to determine a first pitch angle for maximum power production. Another look-up table or continuous calculation based on at least the measured movement or the tension force of the wind turbine may be used to determine a second pitch angle for reducing the relative movement of the wind turbine structure. In an exemplary embodiment, the first and second pitch angles may be combined before transmitting an activation command to the pitch system. In one embodiment, the control unit is connected to a yaw system configured to yaw the nacelle relative to the wind turbine tower, wherein the control unit is configured to determine a corrected yaw angle based on the tension force, or the relative movement.

Alternatively or additionally, the yaw system of the wind turbine is used to move/push the wind turbine structure along the x- and/or z-axis. The control unit is configured to adjust the yaw angle of the wind turbine blades based on the relative movement which in turn regulates the thrust acting on the rotor hub. This corrected yaw angle, e.g. yaw error, is indicative of the direction in which the wind turbine structure needs to be moved to dampen the oscillating movements. The corrected yaw angle is then transmitted to the yaw system which in turn adjusts the yaw angle accordingly. If no correction is needed, then the yaw system yaws the rotor into alignment with the prevailing wind direction, e.g. perpendicularly to the wind direction. The corrected yaw angle may be determined by the control unit based on the measured relative movement of the wind turbine structure or the measured/calculated tension force, e.g. by means of a look-up table or a continuous calculation. The corrected yaw angle for reducing the relative movement of the wind turbine structure may be the same or differ from the optimal yaw angle for maximum power production. This allows the wind turbine to be yawed and/or pitched into an optimal position in which the relative movement of the wind turbine structure is reduced.

Alternatively, one or more position regulating units are arranged relative to the foundation and configured to apply a restoring force to the wind turbine structure in at least one axial direction. Preferably two or more position regulating units may be arranged on or integrated into the foundation for better controlling the movement which allows the wind turbine structure to be moved in at least two axial directions, e.g. the x-axis and z-axis. The position regulating units may be thrusters, water jet nozzles, propellers or any other suitable position regulating unit. The position regulating units may be controlled by the control unit via a wired or wireless connection, e.g. individually or in one or more groups. The rotation of the thrusters or propellers may be reversed, if needed. This allows for a faster and more energy effective way of moving the wind turbine structure compared to the use of the pitch or yaw system.

In a special embodiment, the measuring unit is arranged relative to the mooring system and the control unit is further configured to determine at least:
a tension force in at least one of the mooring lines,
an angle of the at least one mooring line, or
an elastic response, e.g. a relative movement, of the at least one mooring line.

The measuring unit may be a tension measuring unit in the form of a load sensor, a tension meter, or a strain gauge configured to measure the tension in the respective mooring line. The tension measuring unit may further comprise an integrated angular sensor or inclinometer for measuring the angle of the mooring line. This allows the tension and the angle to be measured by using a single unit.

Another measuring unit may be configured to measure an angle, e.g. an inclined angle, of the respective mooring line relative to a reference axis, e.g. at the connection point. The measuring unit may be a separate inclinometer or angular sensor. The control unit may then use this measured angle to determine/calculate the tension force of the respective mooring line.

Yet another measuring unit may be configured to directly or indirectly measure one or more parameters indicative of an elastic response of the respective mooring line, e.g. by means of one or more types of sensors or transducers. The measuring unit may be a sonar, a depth/pressure sensor, a vibration sensor, a motion sensor, an accelerometer, a gyroscope (e.g. a GPS based gyroscope), or another measuring unit suitable for measuring the elastic response. The control unit may further be configured to determine the elastic response based on the measured data from this measuring unit. The elastic response may be used to indicate the characteristics of the mooring line or to calculate the tension force or horizontal displacement of the mooring line.

Two or more measuring units may be distributed along the length of the mooring line. The measuring unit(s) may be connected to the control unit via a wired or wireless connection. The measuring unit may instead be arranged between the foundation and the mooring line, or between two links in the mooring line.

In one embodiment, the measuring unit is arranged relative to the wind turbine structure and configured to measure the position, e.g. the global or local position, of the wind turbine structure.

The measuring unit may be a position sensor in the form of a global positioning system (GPS) receiver, a differential global positioning system (DGPS) receiver, a global navigation satellite system (GNSS) receiver or any other type of position sensor. The initial position of the wind turbine structure may be determined upon installation and stored in the control unit. The resolution/accuracy of the position unit may be selected so that it is able to sense the position of the wind turbine within a few meters, e.g. within 1 or 2 metres, or within a few centimetres, e.g. within 10 centimetres. The position sensor is configured to sense the position along the x- and z-axes or all three axes. This allows the control unit to determine the position of the wind turbine and detect any axial movement along the axes based on the initial position.

A local positioning system (LPS) may instead determine the geographic position of the wind turbine structure. A local position unit is arranged on the wind turbine structure which is in communication with one or more stationary base/reference units. The local position unit may then use triangulation, trilateration, multi-alteration or another technique to determine the position of the wind turbine structure.

The control unit may further be configured to determine the tilting/rotating movement of the wind turbine based on the signals from the position sensor. This enables the control unit to also reduce any tilting or oscillation of the wind turbine caused by the various thrusts acting on the wind turbine structure.

In one embodiment, at least one of the wind turbine blades comprises a first blade section having a first aerodynamic profile and a second blade section having a second aerodynamic profile, wherein the pitch system is arranged between the two blade sections and configured to pitch the second blade section relative to the first blade section at wind speeds above a first wind speed.

This configuration is suitable for wind turbines having traditional pitchable wind turbine blades as well as wind turbines having partial-pitchable wind turbine blades. Two or three wind turbine blades each having a length of at least 35 metres may form part of the rotor. The inner blade section may have a first aerodynamic profile, such as a stall-regulated profile, while the outer section may have a second aerodynamic profile, such as a pitch-regulated profile. The first wind speed may define a rated power output for that wind turbine. The partial-pitchable wind turbine provides a better and more effective control of the thrusts acting on the rotor hub than a traditional pitch-regulated wind turbine, particularly at wind speeds above the rated wind speed.

An object of the invention is also achieved by a control method characterised by:
the control unit detects the relative movement of the wind turbine structure in at least two directions along the one axis within a predetermined time window, and
wherein the step of moving the wind turbine structure comprises regulating the thrust acting on a rotor of the wind turbine structure based on the relative movement for reducing the constant wear in the mooring system if movement in two opposite directions is detected.

This provides a method for dampening the dynamic or cyclic movements of the wind turbine structure in at least the horizontal plane during various wind and marine conditions. This in turn allows the oscillating movement of the anchor chains to be damped, thus reducing the constant wear which increases the lifetime of the mooring system. The wind turbine itself is used to apply an additional restoring force or thrust to the wind turbine structure which stabilises the wind turbine structure and dampens the oscillating movement of the wind turbine structure.

This configuration provides a better and more effective method for reducing the axial movement compared with the traditional moored floating foundations. Previously, tension legs have been used to limit the axial movement of the wind turbine structure; however, these tension legs do not provide a satisfying solution for dampening the axial movement in the horizontal plane. The present configuration regulates the thrust acting on the rotor hub by adjusting the pitch and/or yaw angle based on the relative movement of the wind turbine structure, thereby actively dampening the oscillating movements in the mooring system compared to other known mooring systems which passively dampen these movements.

This configuration dampens the constantly shifting directional movement of the wind turbine structure caused by various dynamic or cyclic forces acting on the wind turbine structure. This in turn also dampens the oscillating movement of the anchor chains so that the constant wear is reduced. This configuration allows the wind turbine structure to move between any equilibrium positions in any direction relative to its initial position due to the static or mean forces acting on the wind turbine structure. Once a movement in at least two axial directions is detected, a restoring force is applied to the wind turbine structure which counteracts the oscillating or cyclic movement. This reduces the loads experienced in the wind turbine structure.

The axial movement is measured directly by using one or more measuring units, e.g. position units, arranged on the wind turbine structure or the mooring system. The position unit measures the geographic position and the control unit determines the relative movement of the wind turbine structure. Alternatively, the tension force is measured by using one or more measuring units, e.g. tension measuring units, arranged relative to the mooring system. The axial movement may then be calculated as function of the measured tension force of the mooring lines. The tension force may be proportional to the relative movement. This enables the control unit to monitor the relative movement of the wind turbine structure and/or tension force in the mooring lines.

In a special embodiment, the tension force or the relative movement in at least one of the two directions is compared to at least one threshold value, e.g. within a predetermined time window, and the thrust is regulated if the threshold is exceeded.

This configuration enables the control unit to detect any fast movements which normally causes the wind turbine structure to relative quickly change its position in at least the horizontal plane, thereby introducing significant loads in the wind turbine. Preferably, the control unit monitors the relative movement along x- and z-axes and compares the respective relative movement in at least two directions to individual thresholds. If the relative movement within the time window remains within the band defined by the threshold value, then the control unit does not adjust the pitch and/or yaw angle of the wind turbine and the wind turbine structure is able to move in any direction towards an equilibrium position. This enables the pitch and/or yaw system to place the rotor/wind turbine blades in the optimal pitch and/or yaw angle for maximum power production. Also, the control unit is able to monitor the speed at which the wind turbine structure moves. The pitch and/or yaw angle are not adjusted by the control unit if the measured speed remains below the speed defined by the time window and the threshold value. If the relative movement exceeds the band or speed threshold, then the control unit generates a corrected pitch and/or yaw angle which is transmitted to the respective pitch and yaw systems which adjust the pitch and yaw accordingly. This applies a restoring force to the wind turbine structure which counteracts the dynamic or cyclic movements and thus oscillating movements in the anchor chains.

The control unit may further monitor the current position of the wind turbine relative to a predetermined reference position, e.g. the anchors or the initial position of the wind turbine structure, to determine the geographic displacement of the wind turbine structure. If this displacement exceeds another threshold value in any one direction along any one of the axes, then the control unit adjusts the pitch and/or yaw angle of the wind turbine to introduce a restoring force which moves the wind turbine structure towards its initial position and/or another equilibrium position. If the wind turbine does not drifts outside the area set by the threshold values, the wind turbine may be operated at optimal pitch and/or yaw angle for maximum power production. This allows the maximum tension in the anchor chains to be reduced as the wind turbine structure moves relative to the anchors.

Alternatively, the control unit monitors the tension force in the mooring system and compares it to one or more predetermined threshold values. If the threshold value is exceeded, then the pitch and/or yaw angle are corrected and the wind turbine structure is moved towards a new position. If the measured tension force remains below the threshold, then the pitch and/or yaw angle are not corrected. This also allows the maximum tension in the anchor chains to be reduced.

In one embodiment, at least a part of the wind turbine blades are pitched into an optimal pitch angle based on the relative movement and/or the nacelle is yawed into an optimal yaw angle based on the relative movement.

The pitching enables the wind thrust acting on the rotor hub to be used to move/push the wind turbine structure along the x- and z-axes towards its initial position or another equilibrium position. The pitching may be carried out by the pitching system where the control unit determines the corrected pitch angle and/or the optimal pitch angle for maximum power production, e.g. based on the measured wind speed and/or wind direction. The respective pitch angles may be determined according to a look-up table or carried out by a continuous calculation. This reduces the number of additional components needed to move the wind turbine structure and enables the control method to be implemented in the existing floating wind turbines.

In an exemplary embodiment, the control unit further determines a corrected yaw angle based on the relative movement. This enables the rotor to be yawed in either direction and thereby using the wind thrust acting on the rotor to move/rotate the wind turbine structure. By yawing the rotor plane out of the wind, e.g. placing the rotor plane with a yaw error relative to the prevailing wind direction, it enables the aerodynamic loads to be increased when the wind turbine blades face the wind and subsequent to be reduced when facing away from the wind, thereby allowing the wind turbine structure to rotate around its y-axis. The respective yaw angles may be determined according to a look-up table or carried out by a continuous calculation. This enables the control unit to place the wind turbine blades and the nacelle in an optimal position for moving/pushing the wind turbine structure towards its initial position or another equilibrium position.

The corrected yaw angle and/or pitch angle are determined based on the measured tension force in the mooring system. The tension force may be calculated based on the relative movement by using a continued calculation or a look-up table. The measured wind speed and/or wind direction may be used as a parameter when determining the corrected pitch angle and/or yaw angle.

In one embodiment, the step of measuring the axial movement comprises at least:
measuring a tension force in at least one of the mooring lines,
measuring an angle of the at least one mooring line, or
measuring an elastic response, e.g. the relative movement, of the at least one mooring line.

The tension force or relative movement is measured using one or more measuring units in the form of tension measuring units or position units. The measuring unit or another measuring unit may further measure an inclined angle of the mooring line or parameters indicative of the elastic response of the mooring line. The tension force is then determined or calculated based on the measured data from these measuring units. This allows multiple parameters indicative of the characteristics of the mooring system to be measured at the same time, thus allowing for a more accurate calculation of the tension force or control of the relative movement.

In one embodiment, the wind turbine structure is moored to the seabed by the mooring system which comprises a plurality of catenary mooring lines, wherein one or more elements, e.g. weight elements, are provided on the mooring system for reducing the movement of at least a part of the mooring system.

The control method enables the oscillating movement of one or more mooring lines to be reduced by using any number of weight elements, e.g. at least two, having a predetermined size and weight. The weight elements may be distributed along the length of the mooring line and/or arranged in one or more rows along the mooring lines. The weight elements are preferably suspended at a position located between the foundation and the seabed. The weight element may be shaped as annular element through which the mooring line extends, a clump weight suspended from/connected to the mooring line, a chain/bendable element having any number of chain/bendable links connected to a first and second mooring line at either end, or any other suitable shape. This allows at least the outermost part of the mooring line to remain on the seabed and thereby acting as a second anchor. The weight elements reduce the angle between the vertical centre line of the foundation and the mooring lines extending outwards from the foundation and increase the pre-tension force in the mooring lines. This increases the restoring force or stiffness of the mooring system thus dampening the movement of the wind turbine structure.

The movement of the electrical cables is reduced by using any number of buoyant elements, e.g. at least one. The buoyant elements may be distributed along the length of the electrical cables and/or arranged in one or more rows along the electrical cables. The buoyant element is configured to have a predetermined shape or size and buoyancy. This allows the section of electrical cables extending into or along the seabed to be kept more or less in the same position while the section of electrical cables located towards the foundation is allowed to move with the foundation. Alternatively, a pump may be located in one or more of the buoyant elements for regulating the buoyancy of that element, e.g. by pumping seawater in and out of a chamber partly filed with air or another compressible medium, e.g. gas. The operation of the pump may be controlled by the control unit so that the position/depth of the buoyant elements is regulated individually or in groups relative to the axial movement of the wind turbine structure. The buoyant elements may be used instead of or combined with the weight elements to reduce the movement of the mooring lines. By connecting the buoyant elements to the mooring lines means that most of the restoring force is provided by the line section located between the foundation and the buoyant elements.

### DESCRIPTION OF THE DRAWING

The invention is described by example only and with reference to the drawings, wherein:

FIG. 1 shows an exemplary embodiment of a wind turbine installed on a floating foundation according to the invention;

FIG. 2 shows a first embodiment of a mooring system connected to the wind turbine structure of FIG. 1;

FIG. 3 shows a second embodiment of the mooring system connected to the wind turbine structure of FIG. 1;

FIG. 4 shows a first exemplary graph of the global position of the wind turbine structure in a horizontal direction relative to the global position in a vertical direction;

FIG. 5 shows a second exemplary graph of the global positions shown in FIG. 4 in a time domain; and

FIG. 6 shows a third exemplary graph of the mooring force of the mooring system relative to the global position in the horizontal position.

In the following text, the figures will be described one by one and the different parts and positions seen in the figures will be numbered with the same numbers in the different figures. Not all parts and positions indicated in a specific figure will necessarily be discussed together with that figure.

### DETAILED DESCRIPTION OF EMBODIMENTS OF THE INVENTION

1 Wind turbine

2 Foundation

3 Wind turbine tower

4 Nacelle

5 Yaw system

6 Rotor hub

7 Wind turbine blades

8 Tip end

9 Blade root

10 Pitch system

11 Blade sections

12 Buoyant body

13 Sea level

14 Mooring system

15 Seabed

16 Mooring lines

17 Anchors

18 Weight elements

19 Electrical cables

20 First buoyant elements

21 Thruster

22 Second buoyant elements

23 First graph

24 Horizontal movement

25 Vertical movement

26 Second graph

27 Third graph

28 Mooring force

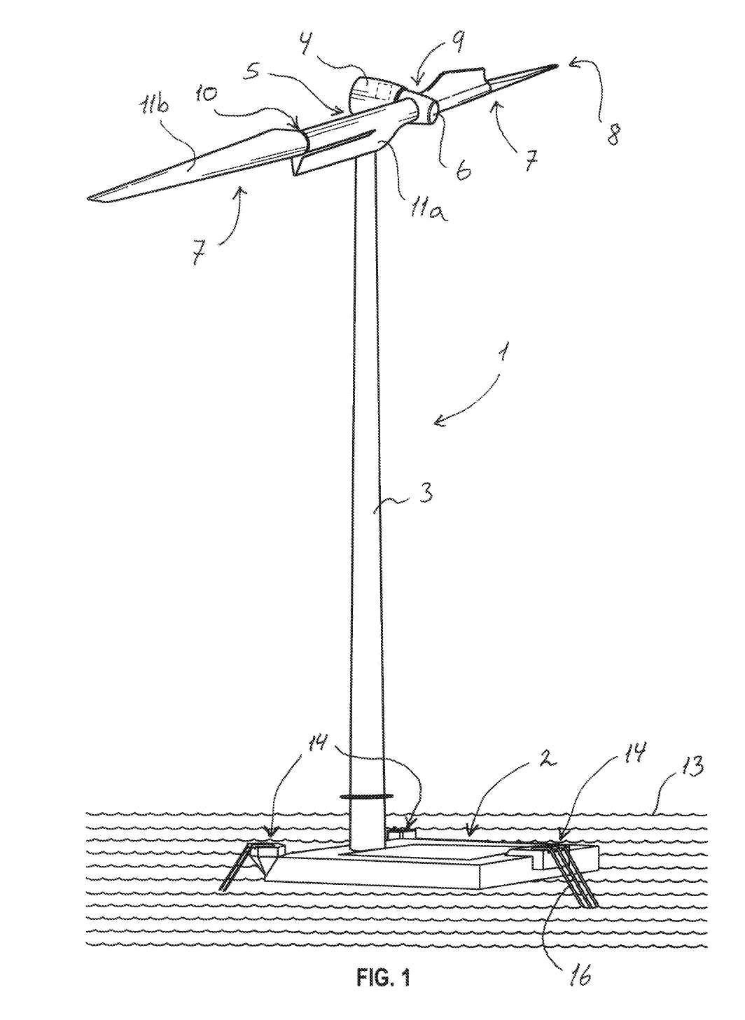

FIG. 1 shows an exemplary embodiment of a wind turbine 1 installed on a floating foundation 2 according to the invention. The wind turbine 1 comprises a wind turbine tower 3 having a bottom end mounted to an upper section of the foundation 2. A nacelle 4 is arranged at a top end of the wind turbine tower 3, e.g. via a yaw system 5. A rotatable rotor is connected to the nacelle 4 and comprises a rotor hub 6 to which two or more wind turbine blades 6 are connected. Each wind turbine blade 7 comprises a tip end 8 and a blade root 9 which is connected to the rotor hub 6. A pitch system 10 is arranged between the blade root 9 and the rotor hub 6 or between a first blade section 11a and a second blade section 11b as shown in FIG. 1. The first blade section 11a has a first aerodynamic profile, e.g. a stall-regulated profile, and the second blade section 11b has a second aerodynamic profile, e.g. a pitch-regulated profile. The pitching and/or yawing of the wind turbine 1 are controlled by a control unit (indicated with dotted lines).

The floating foundation 2 comprises a buoyant body 12, e.g. an elongated and/or cylindrical body, configured to be partly or fully submerged below a water surface 13. The body 12 comprises at least one buoyant chamber in the form of a ballast chamber which is at least partly filled with a ballast material, such as water, rocks, sand/gravel, concrete, metal or another suitable ballast material. Alternatively, the upper section of the body 12 comprises a closed chamber filled with a gaseous medium, such as air, helium or another suitable gas. The upper section comprises mounting means for mounting the bottom of the wind turbine tower 3 to the foundation 2. The body 12 may be made of iron, steel, concrete or another suitable material.

A mooring system 14 is connected to the foundation 2 for securing the wind turbine structure to a seabed 15 at an installation site. The mooring system 14 comprises at least three mooring lines 16 extending outwards from the foundation 2. Each mooring line 16 is connected to the foundation 2 at one end and to an anchor 17 at the other end. The mooring lines 16 may be large and heavy anchor chains made of metal, e.g. steel. The anchor 17 is a draft anchor or a similar type anchor using friction to secure the wind turbine structure to the seabed 15 as it moves.

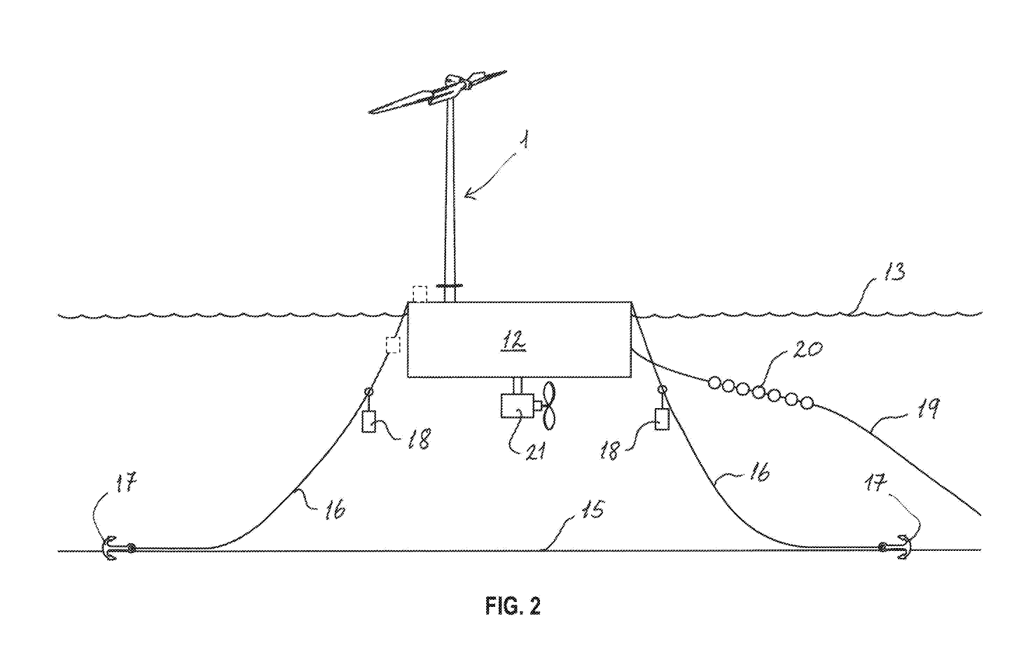

FIG. 2 shows a first embodiment of the mooring system 14 connected to the wind turbine structure of FIG. 1. One or more weight elements 18 in the form of clump weights are distributed along the length of at least one of the mooring lines 16. Each weight element 18 is suspended from the respective mooring line 16 at a predetermined position. The weight elements 18 apply tension to the innermost part of the mooring line 16, e.g. the section between the weight 18 and the foundation 2, while allowing the outermost part of the mooring line 16, e.g. the section between the weight 18 and the anchor 17, to remain on the seabed 15, thus acting as a second anchor. This counteracts the relative movement of the wind turbine structure and increase the restoring force of the mooring lines 16.

At least one set of electrical cables 19 extends outwards from the foundation 2 and into or along the seabed 15. One or more first buoyant elements 20 are distributed along the length of the electrical cables 19, e.g. in a row. Each buoyant element 20 in the row has a predetermined shape or size and buoyancy. This reduces the movement of the electrical cables 19, particularly at the transition area in which the cables contact the seabed 15, as the wind turbine structure moves around.

At least one position regulating unit 21 in the form of a thruster, e.g. a rotatable thruster, is arranged at the bottom of the foundation 2. The position regulating unit 21 is connected to the control unit which controls the operation thereof. The control unit is connected to at least one measuring unit (indicated with dotted lines) located on the wind turbine structure, e.g. the foundation 2 or the nacelle 4. The measuring unit can alternatively be arranged relative to the mooring system 14. The measuring unit may be a GPS receiver configured to detect the global position of the wind turbine structure, e.g. along all three axes. The control unit uses the signal from the measuring unit to determine the relative movement of the wind turbine structure in at least two different directions, e.g. in opposite directions along the x- or y-axis or any combination thereof. The control unit monitors the relative movement within a predetermined time window, e.g. of 10 to 120 seconds. The measured movement in one or both directions is then compared to a predetermined threshold value, e.g. of 50 to 200 centimetres. If the measured movement within the time window exceeds the threshold value in at least one direction, then the position regulating unit 21 is activated. If the measured movement is below the threshold value, then the position regulating unit 21 is not activated. This allows the wind turbine structure to be moved towards an equilibrium position in which the wind turbine structure is stabilized. This control method dampens any fast oscillating movements due to the dynamic or cyclic forces acting on the wind turbine structure.

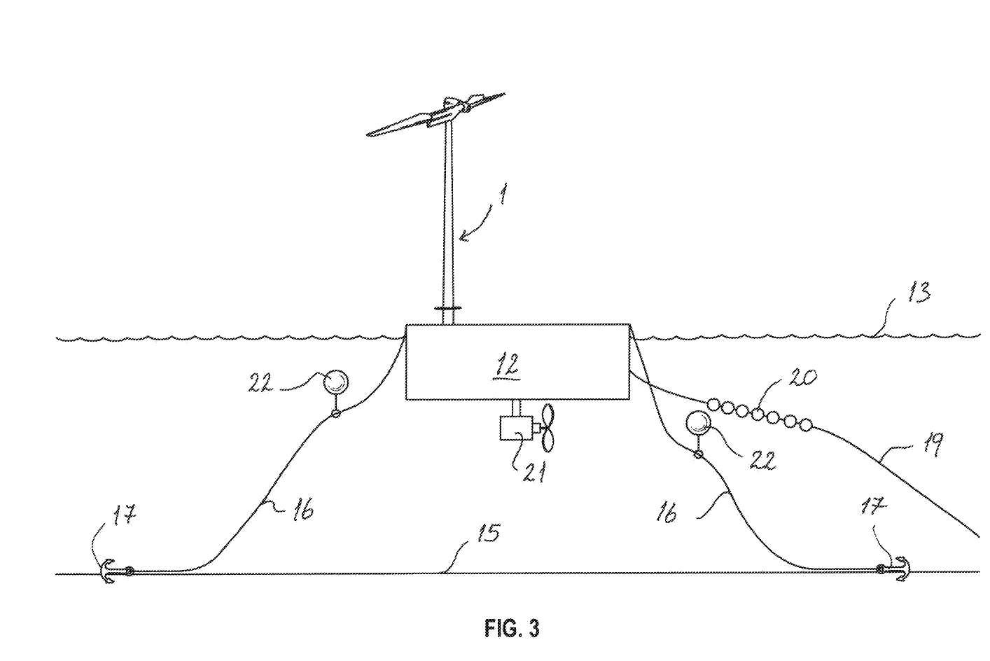

FIG. 3 shows a second embodiment of the mooring system 14 connected to the wind turbine structure of FIG. 1. In this embodiment, the weight elements 18 are replaced by any number of second buoyant elements 22. The shape, size or buoyancy of the second buoyant elements 22 differs from the shape, size or buoyancy of the first buoyant elements 20. This allows the outermost part of the mooring lines 16 to more or less remain on the seabed 15 and act as an anchor while the innermost part of the mooring line 16 is able to move with the wind turbine structure. The innermost part is configured to provide most of the restoring force transferred to the foundation 2, i.e. providing a restoring force that is greater than the restoring force provided by the outermost part.

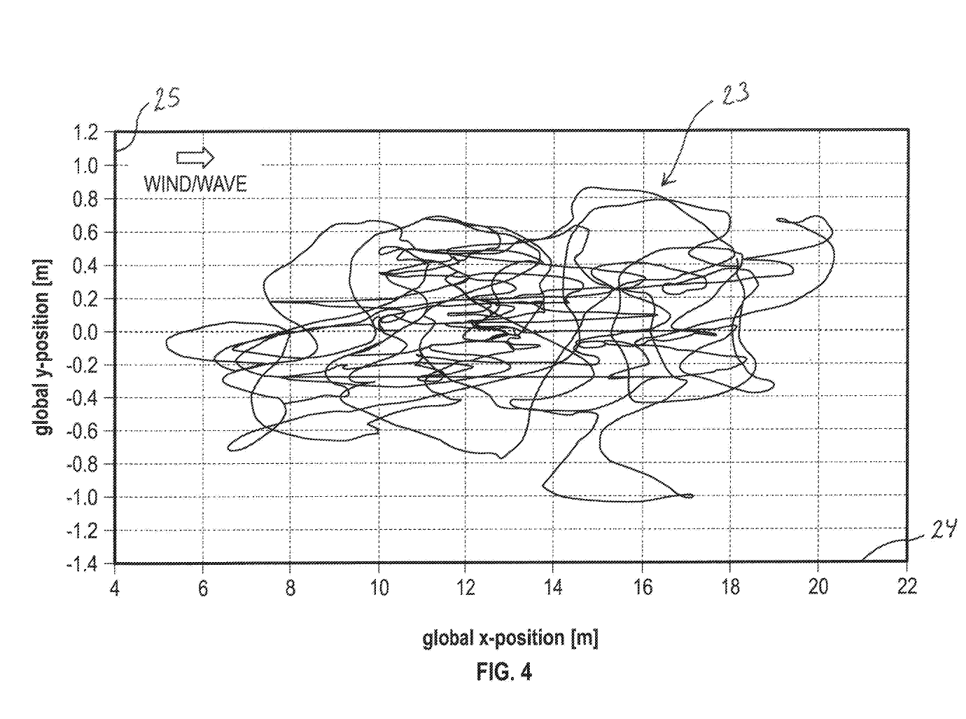

FIG. 4 shows a first exemplary graph 23 of the global position of the wind turbine structure in a horizontal plane relative to the global position in a vertical plane. The x-axis of the graph 23 denotes the axial movement 24 along the x-axis in the horizontal plane. The y-axis of the graph 23 denotes the axial movement 25 along the y-axis in the vertical plane. The graph 23 shows the global position of the wind turbine 1 operating at the rated power output influenced by the waves and wind at a mean wind speed of 20^{m}/ₛ. In this embodiment, the position regulating unit 21 is not activated. As shown in the graph 23, the wind turbine structure substantially moves 24 within a range of +6 to +20 metres from its initial position along the x-axis while the wind structure substantially moves 25 within a range of −1 to +1 metres along the y-axis from its initial position. The movement 24, 25 of the wind turbine structure changes directions several times within these two ranges. The present invention aims to counteract these constant shifts in direction using the position regulating unit 21.

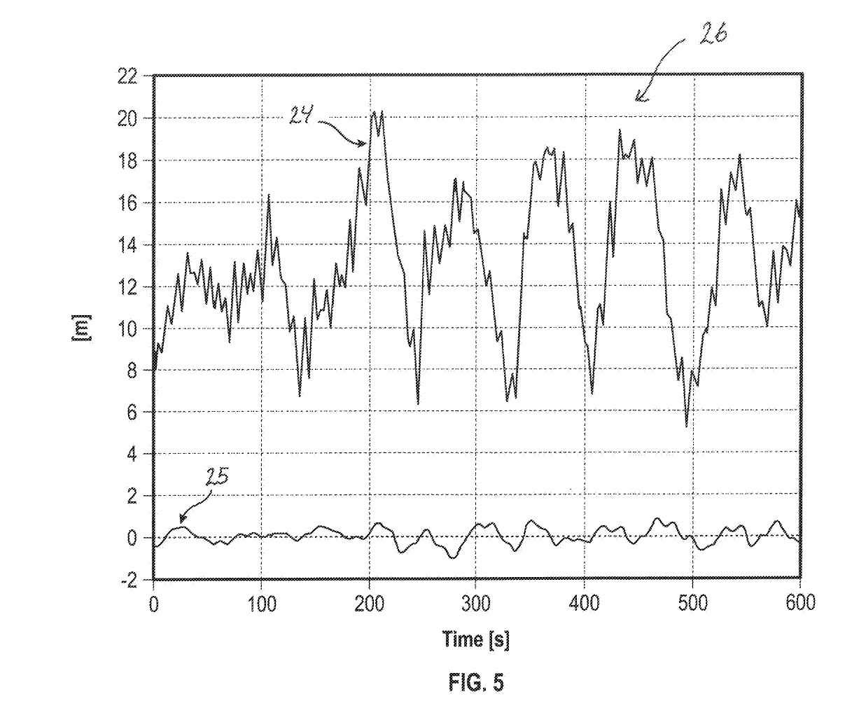

FIG. 5 shows a second exemplary graph 26 of the global positions shown in FIG. 4 in a time domain in both the horizontal and vertical planes. As indicated in the graph 26, the forces acting on wind turbine structure causes it to move a relative fast oscillating/cyclic manner that constantly moves the wind turbine structure in opposite directions. If the control unit detects thus a fast movement (relative movement exceeds the threshold value within the time window), then the position regulating unit 21 is activated to dampen this oscillating/cyclic movement.

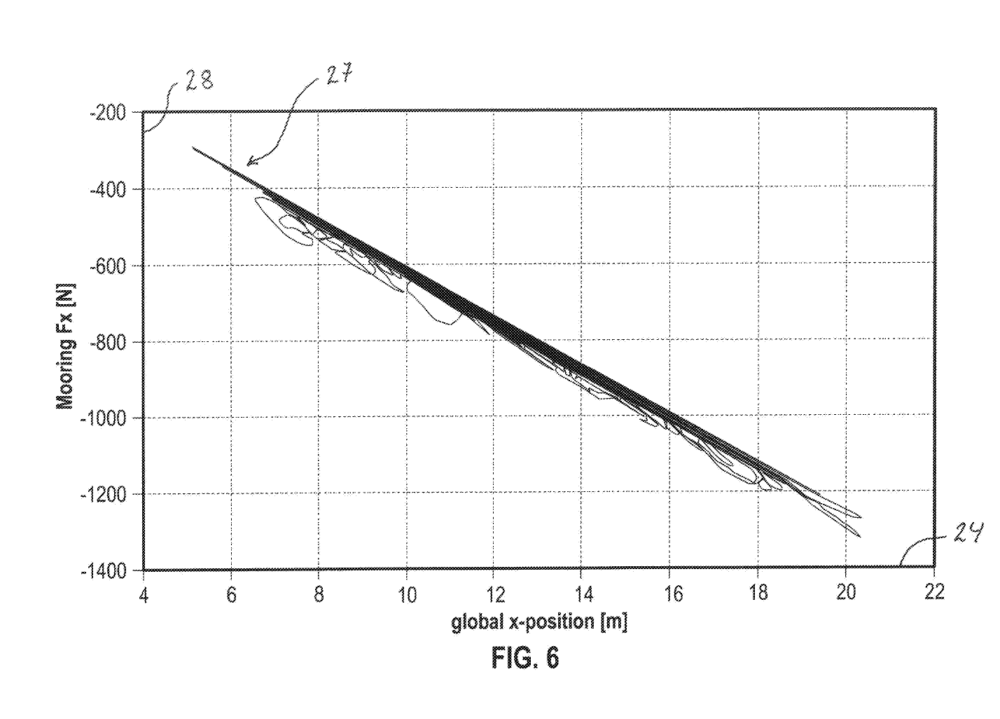

FIG. 6 shows a third exemplary graph 27 of the restoring force, e.g. tension force, of the mooring system 14 relative to the global position, e.g. relative movement, in the horizontal plane. The x-axis of the graph 27 denotes the axial movement 24 along the x-axis in the horizontal plane while the y-axis denotes the force 28 experienced in the mooring line 16. As shown in the graph 27, the restoring force Fx experienced in upwind facing mooring lines indicated in FIG. 1 is more or less proportional to the movement 24 in the horizontal plane, e.g. the movement 24 along the x-axis. This indicates that the position regulating unit 21 can be used to also dampen the oscillating movement in the mooring lines 16 by dampening the dynamic movement of the wind turbine structure.

In this configuration, the control unit calculates the tension force in the mooring lines 16 based on the relative movement 24 of the wind turbine structure. The calculated tension force, e.g. for each mooring line, is then compared to a predetermined threshold value. If the calculated tension force is above the threshold value, then the control unit determines an optimal pitch angle for the wind turbine blades 7. The wind turbine blades 7 are then pitched into this optimal pitch angle so that the wind turbine structure is moved to another position in which the maximum tension force in the tensioned mooring lines 16 is reduced.

1-14. (canceled)

15. A wind turbine structure comprising:
a wind turbine tower having a top and a bottom,
a nacelle arranged on top of the wind turbine tower,
a rotor hub rotatably mounted to the nacelle,
one or more pitchable wind turbine blades with a tip end and a blade root mounted to the rotor hub,
a floatable foundation having an upper section mounted to the bottom of the wind turbine tower, wherein the foundation comprises a buoyant body configured to be installed at an offshore position,
a mooring system having a plurality of catenary mooring lines, the mooring system being connected to the foundation and to at least one anchor arranged on a seabed,
wherein the wind turbine structure comprises at least one control unit connected to at least a pitch system configured to pitch the wind turbine blades and at least one measuring unit connected to the at least one control unit, the at least one measuring unit is configured to measure an axial movement of the wind turbine structure along at least one axis in a horizontal plane, wherein
the at least one control unit is configured to detect the relative movement of the wind turbine structure relative to a predetermined position in at least two directions along the at least one axis within a predetermined time window, and
the at least one control unit is configured to move the wind turbine structure in the horizontal plane by adjusting a thrust acting on a rotor based on the relative movement, if movement in two opposite directions is detected, to reduce constant wear in the mooring system.

16. A wind turbine according to claim 15, wherein the time window is less than 3 minutes.

17. A wind turbine according to claim 15, wherein the time window is between 10 to 120 seconds.

18. A wind turbine according to claim 15, wherein the at least one control unit is configured to compare the relative movement in at least one of the two directions to at least one threshold, wherein the at least one control unit is configured to adjust the thrust acting on the rotor if the relative movement exceeds that threshold.

19. A wind turbine according to claim 18, wherein the at least one threshold is between 50 to 200 centimetres.

20. A wind turbine according to claim 19, wherein the at least one threshold is 100 centimetres.

21. A wind turbine according to claim 15, wherein the at least one control unit is configured to determine an optimal pitch angle based on the relative movement.

22. A wind turbine according to claim 15, wherein the at least one control unit is further connected to a yaw system configuration to yaw the nacelle and the rotor relative to the wind turbine tower, wherein the at least one control unit is configured to determine an optimal yaw angle based on the relative movement.

23. A wind turbine according to claim 15, wherein the at least one measuring unit is arranged relative to the mooring system and the at least one control unit is further configured to determine at least:
a tension force in at least one of the mooring lines,
an angle of the at least one mooring line, or
an elastic response of the at least one mooring line.

24. A wind turbine according to claim 23, wherein the elastic response is determined as a relative movement of the at least one mooring line.

25. A wind turbine according to claim 15, wherein the at least one measuring unit is arranged relative to the wind turbine structure and configured to measure the position of the wind turbine structure.

26. A wind turbine according to claim 25, wherein the position is a global or local position of the wind turbine structure.

27. A wind turbine according to claim 15, wherein at least one of the wind turbine blades comprises a first blade section having a first aerodynamic profile and a second blade section having a second aerodynamic profile, wherein the pitch system is arranged between the two blade sections and configured to pitch the second blade section relative to the first blade section at wind speeds above a first wind speed.

28. A method of controlling a wind turbine structure according to claim 15, wherein the method comprises the steps of:
pitching the wind turbine blades into a pitch angle at mean wind speeds above a first wind speed,
measuring an axial movement of the wind turbine structure in the horizontal plane,
predetermining the relative movement of the wind turbine structure relative to a predetermined position,
moving the wind turbine structure relative to a predetermined position in at least the horizontal plane, wherein
the relative movement of the wind turbine structure is detected by the at least one control unit in at least two directions along the at least one axis within a predetermined time window, and
wherein the step of moving the wind turbine structure comprises regulating the thrust acting on the rotor of the wind turbine structure based on the relative movement for reducing the constant wear in the mooring system if movement in two opposite directions is detected.

29. A method according to claim 28, wherein the relative movement in at least one of the two directions is compared to at least one threshold value, and the thrust on the rotor is regulated if the threshold is exceeded.

30. A method according to claim 28, wherein at least a part of the wind turbine blades are pitched into an optimal pitch angle based on the relative movement and/or the nacelle is yawed into an optimal yaw angle based on the relative movement.

31. A method according to claim 28, wherein the step of measuring the axial movement comprises at least:
measuring a tension force in at least one of the mooring lines,
measuring an angle of the at least one mooring line, or
measuring an elastic response, e.g. the relative movement, of the at least one mooring line.

32. A method according to claim 31, wherein the elastic response is measured as the relative movement of the at least one mooring line.

33. A method according to claim 28, wherein the wind turbine structure is moored to the seabed by the mooring system which comprises a plurality of catenary mooring lines, wherein one or more elements are provided on the mooring system for reducing the movement of at least a part of the mooring system.

34. A method according to claim 33, wherein said one or more elements are weight elements.
